(19) United States
(12) Patent Application Publication
(10) Pub. No.: US 2010/0180401 A1
(43) Pub. Date: Jul. 22, 2010

(54) HINGE HOUSING FOR HINGE ASSEMBLY

(75) Inventors: CHAO DUAN, Shenzhen City (CN); CHIA-HUA CHEN, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/549,079

(22) Filed: Aug. 27, 2009

(30) Foreign Application Priority Data
Jan. 16, 2009 (CN) 200910300245.5

(51) Int. Cl. E05D 11/00; E05D 7/00

(52) U.S. Cl. 16/250; 16/221

(57) ABSTRACT

A hinge assembly includes a pivot shaft, a rotary element, an elastic element, a cam and a hinge housing. The rotary element is slidable and rotatable relative to the pivot shaft. The elastic element is placed around the pivot shaft. The cam is engaged with the rotary element by the elastic element. The cam is fixed with the shaft. The hinge housing has an open end and a partially-closed end. The receiving portion is formed adjacent to the open end. The receiving portion is radially expandable. The pivot shaft passes through the hinge housing from the partially-closed end. The elastic element is received in the hinge housing, and is placed around the shaft. The cam is received in the receiving portion.

### BACKGROUND

1. Technical Field

The present disclosure relates to hinge housings, and particularly to a hinge housing for a hinge assembly for foldable electronic devices, such as mobile phones and portable computers.

2. Description of Related Art

Presently, perhaps the most popular portable electronic device in the marketplace is the foldable mobile phone, which generally includes a cover section and a body section. The cover section and the body section are rotatably interconnected through a hinge assembly, for switching the mobile phone between an in-use position and a closed position.

A typical hinge assembly used in small foldable electronic devices includes a shaft, a cam, a follower, a spring, a hinge housing and a washer. The hinge housing has a partially-closed end and an open end. The cam and the spring are placed around the shaft, and are received in the hinge housing. The washer is locked at one end of the shaft, and resists the partially-closed end of the hinge housing. The follower is partially received in the hinge housing from the open end, and is secured on the other end of the shaft. Thus, the hinge assembly is completely assembled.

The hinge housing generally forms two symmetric flat surfaces along an outer peripheral wall thereof configured for fixing with a cover section. These two flat surfaces correspond to flat surfaces within a barrel of the cover section. Since the follower is received in one end of the hinge housing, the flat surfaces reduce the size of the receiving space of the hinge housing. Therefore, the flat surfaces of the hinge housing limit the radial size of the follower. The smaller size can potentially lower the strength of the follower, thus reducing the life span of the hinge assembly.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present hinge housing. Moreover, in the drawings, like reference numerals designate corresponding parts throughout the several views, in which:

FIG. 1 is an exploded, isometric view of an exemplary hinge assembly;

FIG. 2 is an enlarged schematic view of the hinge housing of FIG. 1;

FIG. 3 is a side view of FIG. 2;

FIG. 4 is an enlarged, schematic view of the cam; and

FIG. 5 is an assembled, isometric view of the exemplary hinge assembly shown in FIG. 1.

### DETAILED DESCRIPTION

The present hinge housing is adoptable by a hinge assembly used in a manually openeable mobile phone. It is to be understood, however, that the hinge assembly could be advantageously used in other diverse environments (e.g. cabinet doors).

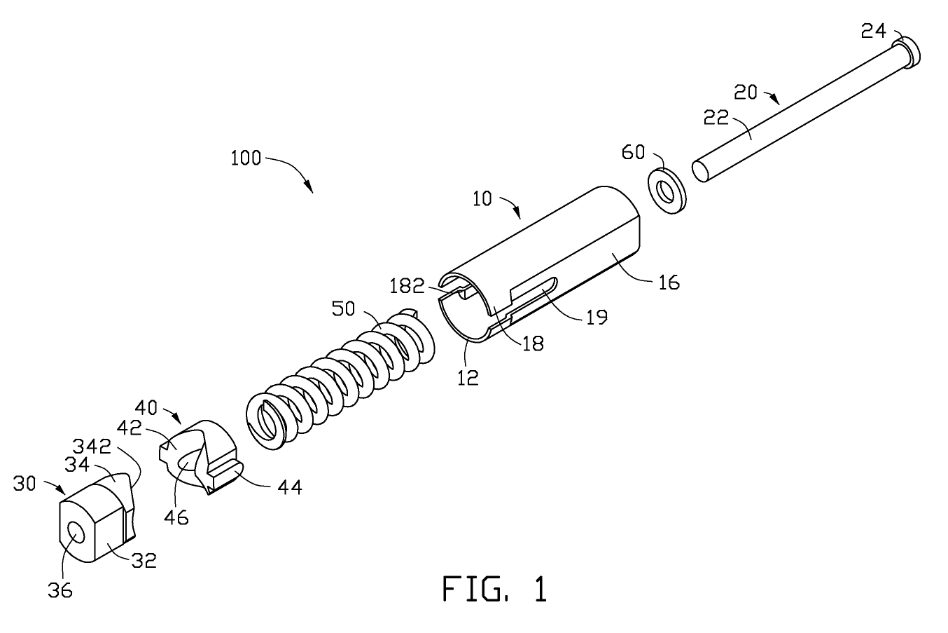

Referring to FIG. 1, an exemplary hinge assembly 100 includes a hinge housing 10, a pivot shaft 20, a cam 30, a rotary element 40, an elastic element 50, and a washer 60.

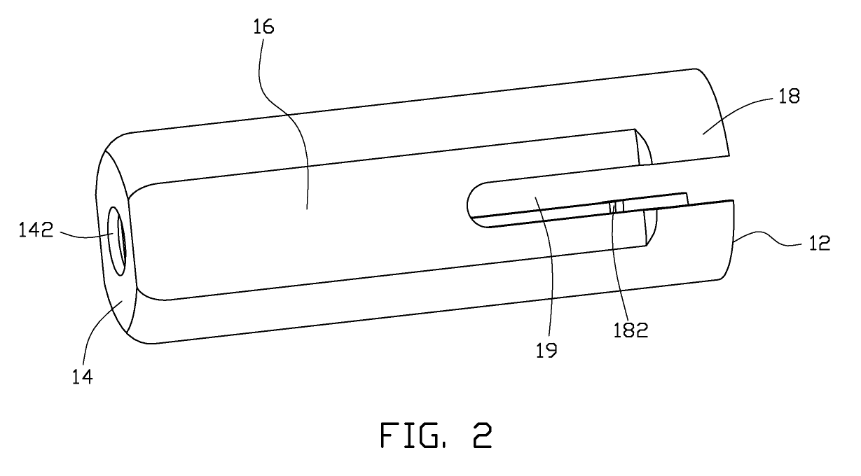

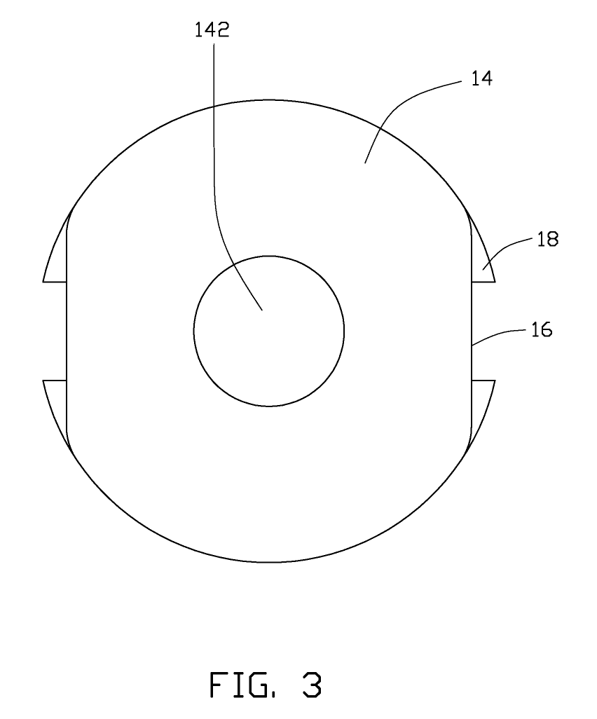

Referring to FIGS. 2 and 3, the hinge housing 10 is substantially a hollow cylinder. The hinge housing 10 includes an open end 12 and a partially-closed end 14. The partially-closed end 14 defines a center hole 142. The hinge housing 10 includes two symmetrical cutouts 19 extending from the open end of the hinge housing 10 to near a middle cylindrical portion of the hinge housing 10. Thus, two prongs 182 are formed. The two prongs 182 contribute to constitute a receiving portion 18. The hinge housing 10 defines two symmetrical flattened surface 16 extending from the partially-closed end 14 on the cylindrical portion of the hinge housing 10. The flat surface portions 16 are configure for engaging with the cover section. As seen in FIG. 2, in the preferred embodiment the cutouts 19 and the flattened surface 16 are aligned with each other, and further partially overlap each other correspondingly. In this exemplary embodiment, the hinge housing 10 is formed by a punch stretch process. The hinge housing 10 from a distal end of the flat surface portions 16 is radially extended outward to form a full circle, thereby forming the receiving portion 18. The receiving portion 18 has a larger cross-section compared to the cross section of the portions of the hinge housing in flat surface portions 16. A cross section of the receiving portion 18 is substantially circular.

The pivot shaft 20 includes a shaft portion 22 and a head portion 24. The head portion 24 is formed at an end of the pivot shaft 20. The shaft portion 22 extends from a side of the head portion 24. A diameter of the shaft portion 22 is smaller than the diameter of the head portion 24.

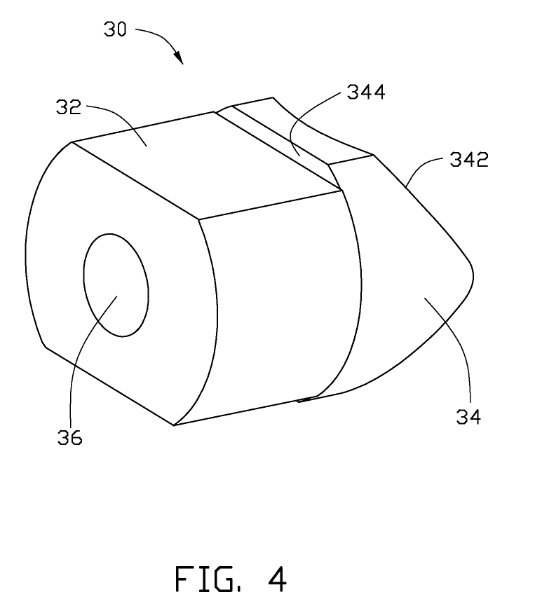

Referring to FIG. 4, the cam 30 is substantially cylindrical, and includes a fixed portion 32 and a cam portion 34 integrally formed together. The fixed portion 32 is for connecting with a body section (not shown). The cam portion 34 forms a cam surface 342 on a side. The cam 30 defines a rectangular passage 36 for receiving the shaft portion 22. Because the cam portion 34 is received in the receiving portion 18 of the hinge housing 10, the larger cross-section of the receiving portion 18 allows a cam having a larger radial size and cross-section to be used; thereby, increasing the strength of the cam 30. In this exemplary embodiment, a radial size of the cam portion 34 is larger than that of the fixed portion 32, thereby forming a ledge 344 at a connection between the fixed portion 32 and the cam portion 34.

The rotary element 40 has a cam latching surface 42 engageable with the cam surface 342 of the cam 30. Two projections 44 are symmetrically formed on an outer periphery of the rotary element 40 extending from one end to the other end. A through hole 46 is defined in the rotary element 40. The projections 44 are slidably engaged in the cutouts 19. The projections 44 may increase the radial strength of the rotary element 40.

The elastic element 50 is preferably made of metal and is spiral-shaped (i.e. a coil spring). An inner diameter of the elastic element 50 is slightly larger than a diameter of the shaft portion 22, as a result, the elastic element 50 can be placed around the pivot shaft 20.

The washer 60 is made of metal, and is sleeved the pivot shaft 20. The washer 60 abuts the head portion 23, thereby reducing friction between the hinge housing 10 and the pivot shaft 20.

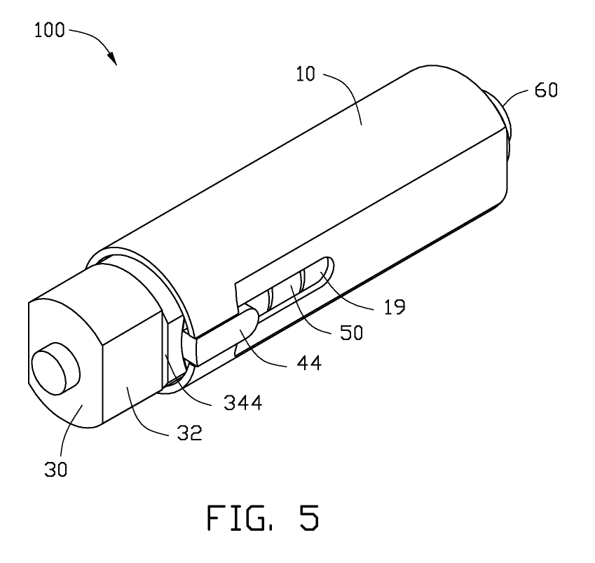

Referring to FIG. 5, during assembly of the hinge assembly 100, the washer 60 is sleeved the pivot shaft 20, and abuts the head portion 24. Then, a free end of the shaft portion 22 of the pivot shaft 20 is inserted through the central hole 142 of the hinge housing 10, and is exposed from the open end 12 of the hinge housing 10. Next, the elastic element 50 and the rotary element 40 are placed around the pivot shaft 20, and are received in the hinge housing 10. One end of the elastic element 50 resists the rotary element 40, the other end of the elastic element 50 resists the partially-closed end 14 of the hinge housing 10. The projections 44 are received in the cutouts 19 of the hinge housing 10. After that, the cam 30 is tightly engaged with the pivot shaft 20, and the cam surface 342 of the cam portion 32 is engaged with the latching cam surface 42, thereby securing the hinge housing 10, the cam 30, the rotary element 40, the elastic element 50, and the washer 60 on the pivot shaft 20.

The described embodiment of the hinge housing having the receiving portion 18, the radial size of the hinge housing 10 is expanded. Accordingly, the radial size of the cam 30 may be expanded. Therefore, the radial strength of the cam 30 is strengthened. In addition, the radial contact area between the cam 30 and the rotary element 40 is increased.

It is to be understood that the elastic element may alternatively be made of another material (e.g. plastic or rubber). The elastic member may alternatively have a different configuration, for example, a leaf spring or a resilient cylinder.

It is believed that the present embodiments and their advantages will be understood from the foregoing description, and it will be apparent that different changes may be made thereto without departing from the spirit and scope of the invention or sacrificing all of its material advantages, the examples hereinbefore described merely being preferred or exemplary embodiments of the invention.

What is claimed is:

1. A hinge housing for a hinge assembly, comprising:
an open end and a partially-closed end;
a receiving portion formed at the open end, the receiving portion being radially expandable.

2. The hinge housing as claimed in claim 1, wherein the hinge housing includes two flat portions, the flat portions extending from the partially-closed end, and being connected with the receiving portion; the cross-section of the receiving portion being larger than the cross-section of the portion of the hinge housing in the flat portions.

3. The hinge housing as claimed in claim 2, wherein two cutouts are defined in the flat portion and the receiving portion, thereby forming two cylindrical prongs allowing the receiving portion to be radially expandable.

4. The hinge housing as claimed in claim 1, wherein a cross section of the receiving portion is circular.

5. The hinge housing as claimed in claim 2, wherein the hinge housing from a distal end of the flat portions is radially extended to form a full circle, thereby forming the receiving portion.

6. A hinge assembly, comprising:
a pivot shaft;
a rotary element having a latching cam surface, the rotary element being slidable and rotatable relative to the pivot shaft;
an elastic element being placed around the pivot shaft;
a cam having a cam surface, the cam surface being engaged with the cam latching surface of the rotary element by the elastic element, the cam being fixed with the shaft;
a hinge housing having an open end and a partially-closed end, a receiving portion formed adjacent to the open end; the receiving portion being radially expandable, the pivot shaft passing through the hinge housing from the partially-closed end, the elastic element, the rotary element being received in the hinge housing, and being placed around the pivot shaft, and the cam being received in the receiving portion.

7. The hinge assembly as claimed in claim 6, wherein a cross section of the receiving portion is circular.

8. The hinge assembly as claimed in claim 6, wherein the hinge housing includes a flat portion, the flat portion extending from the partially-closed end, and is connected with the receiving portion; the cross-section of the receiving portion being larger than the cross-section of the portion of the hinge housing including the flat portions.

9. The hinge assembly as claimed in claim 8, wherein the hinge housing from a distal end of the flat portions is radially extended to form a full circle, thereby forming the receiving portion.
